(19) United States
(12) Patent Application Publication
(10) Pub. No.: US 2024/0169109 A1
(43) Pub. Date: May 23, 2024

(54) DUAL MODEL SHAPE SYNTHESIS

(71) Applicant: Autodesk, Inc., San Francisco, CA (US)

(72) Inventors: Nigel Jed Wesley Morris, Toronto (CA); Adrian Adam Thomas Butscher, Toronto (CA); Pradeep Kumar Jayaraman, Ajax (CA)

(21) Appl. No.: 17/990,301

(22) Filed: Nov. 18, 2022

(51) Int. Cl. G06F 30/20; G06F 30/12

(52) U.S. Cl. CPC G06F 30/20; G06F 30/12; G06F 2113/10

(57) ABSTRACT

Methods, systems, and apparatus, including medium-encoded computer program products include: obtaining a design space for a modeled object, for which a corresponding physical structure is to be manufactured, and one or more design criteria for the modeled object; iteratively modifying a first three-dimensional shape of the modeled object in the design space in accordance with the one or more design criteria, the iteratively modifying includes forming a second three-dimensional shape of the modeled object based on the first three-dimensional shape of the modeled object, where the second three-dimensional shape conforms to a predefined shape-type requirement, and penalizing modifications of the first three-dimensional shape that deviate from the second three-dimensional shape; and providing the first or second three dimensional shape of the modeled object for use in manufacturing the physical structure using one or more computer-controlled manufacturing systems.

### BACKGROUND

This specification relates to computer aided design of physical structures, which can be manufactured using additive manufacturing, subtractive manufacturing and/or other manufacturing systems and techniques, or other structures, which can be provided as a digital asset, such as for use in animation.

Computer Aided Design (CAD) software has been developed and used to generate three-dimensional (3D) representations of objects, and Computer Aided Manufacturing (CAM) software has been developed and used to evaluate, plan and control the manufacture of the physical structures of those objects, e.g., using Computer Numerical Control (CNC) manufacturing techniques. Typically, CAD software stores the 3D representations of the geometry of the objects being modeled using a boundary representation (B-Rep) format. A B-Rep model is a set of connected surface elements specifying boundaries between a solid portion and a non-solid portion of the modeled 3D object. In a B-Rep model (often referred to as a B-Rep), geometry is stored in the computer using smooth and precise mathematical surfaces, in contrast to the discrete and approximate surfaces of a mesh model, which can be difficult to work with in a CAD program.

CAD programs have been used in conjunction with subtractive manufacturing systems and techniques. Subtractive manufacturing refers to any manufacturing process where 3D objects are created from stock material (generally a “blank” or “workpiece” that is larger than the 3D object) by cutting away portions of the stock material. Such manufacturing processes typically involve the use of multiple CNC machine cutting tools in a series of operations, starting with a roughing operation, an optional semi-finishing operation, and a finishing operation. In addition to CNC machining, other subtractive manufacturing techniques include electrode discharge machining, chemical machining, waterjet machining, etc. In contrast, additive manufacturing, also known as solid free form fabrication or 3D printing, refers to any manufacturing process where 3D objects are built up from raw material (generally powders, liquids, suspensions, or molten solids) in a series of layers or cross-sections. Examples of additive manufacturing include Fused Filament Fabrication (FFF) and Selective Laser Sintering (SLS). Other manufacturing techniques for building 3D objects from raw materials include casting and forging (both hot and cold) and molding.

In addition, CAD software has been designed to perform automatic generation of 3D geometry of one or more parts in a design of a physical structure (known as “topology optimization”, “generative design”, or “generative modelling”, among others). This automated generation of 3D geometry often works within a “design domain” specified by a user or the CAD software and generates geometry typically by optimizing design objectives and respecting design constraints, which can be defined by the user, CAD software, or a third party. The design objectives can include but are not limited to minimizing waste material, minimizing the weight of the part, minimizing the compliance, stress, maximum mass, maximum deflection under load, or other intrinsic property of the part, and are used to drive the topology optimization process towards better designs. Though not required, it is typical for a design objective to be rooted in a simulation of the design (linear static, fluid dynamic, electromagnetic, etc.) Design constraints can include a variety of physical characteristics or behaviors that must be met in any generated design (requirements, either on individual parts or on the entire assembly, are also admissible); examples include maximum mass, maximum deflection under load, maximum stress, fixed mass, fixed volume, etc.

Further, the geometric inputs to such a 3D geometry generation tool can include one or more user- or CAD system-provided “keep-in” regions (indicating regions of the design that are to be held fixed, such as surface regions of a boundary of the physical structure where boundary conditions such as prescribed mechanical loads or displacements are applied) or “keep-out” regions (indicating volumetric or surface regions that should be free from the generated 3D geometry). In some cases, the topology optimization process takes place using a different representation of geometry than that employed by the CAD system. For example, a CAD system might use a boundary representation (“B-Rep”) while the geometry generation and optimization engine might employ a boundary-based representation (e.g. a level set-based representation) or a density-based representation embedded in a voxel or tetrahedral mesh.

### SUMMARY

This specification describes technologies relating to computer-aided design of structures, such as three-dimensional physical structures, using dual model shape synthesis, e.g., optimizing the topology of a beam network during automated design of physical structures using generative design processes. The systems and techniques described can be used to optimize the shape and topology of a three-dimensional physical structure and for computer-aided manufacturing of three-dimensional physical structures.

In general, one or more aspects of the subject matter described in this specification can be embodied in one or more methods (and also one or more non-transitory computer-readable mediums tangibly encoding a computer program operable to cause one or more processors to perform operations), including: obtaining, by a computer aided design program, a design space for a modeled object, for which a corresponding physical structure is to be manufactured, and one or more design criteria for the modeled object; iteratively modifying, by the computer aided design program, a first three-dimensional shape of the modeled object in the design space in accordance with the one or more design criteria, wherein the iteratively modifying includes forming a second three-dimensional shape of the modeled object based on the first three-dimensional shape of the modeled object, wherein the second three-dimensional shape conforms to a predefined shape-type requirement, and penalizing modifications of the first three-dimensional shape that deviate from the second three-dimensional shape; and providing, by the computer aided design program, the first or second three dimensional shape of the modeled object for use in manufacturing the physical structure using one or more computer-controlled manufacturing systems.

One or more aspects of the subject matter described in this specification can also be embodied in one or more systems including one or more processors; and a computer-readable medium storing instructions that cause the one or more processors to perform operations including: obtaining, by a computer aided design program, a design space for a modeled object, for which a corresponding physical structure is to be manufactured, and one or more design criteria for the modeled object; iteratively modifying, by the computer aided design program, a first three-dimensional shape of the modeled object in the design space in accordance with the one or more design criteria, wherein the iteratively modifying includes forming a second three-dimensional shape of the modeled object based on the first three-dimensional shape of the modeled object, wherein the second three-dimensional shape conforms to a predefined shape-type requirement, and penalizing modifications of the first three-dimensional shape that deviate from the second three-dimensional shape; and providing, by the computer aided design program, the first or second three dimensional shape of the modeled object for use in manufacturing the physical structure using one or more computer-controlled manufacturing systems.

Forming the second three-dimensional shape can include: extracting a graph from the first three-dimensional shape of the modeled object; and generating the second three-dimensional shape from the graph. The predefined shape-type requirement can be that the second three-dimensional shape is a network of beams.

Generating the second three-dimensional shape from the graph can include: generating each of the beams of the network of beams from a respective edge of the graph. Each of the beams can be assigned a circular cross-section of uniform radius along the beam.

The generating can include one or more of: i) limiting a maximum and/or a minimum value of a beam cross-section of each of the beams of the network of beams; ii) snapping an angle between connected beams to a snapping angle closest to the angle between the connected beams, wherein the snapping angle is equal to a specified angle value or a multiple of the specified angle value; or iii) modifying a cross-section of one or more beams of the network of beams to decrease cross-section differences between substantially collinear beams. The snapping can include solving an optimization problem on the graph using an objective function that measures differences between i) an angle between connected edges of the graph and ii) the closest snapping angle. The modifying can include iteratively updating a radius of each beam taking into account the angle between a respective edge in the graph and edges connected to the respective edge, using a higher contribution from connected edges that are substantially collinear.

The first three-dimensional shape can be stored as a shape boundary representation. The penalizing can include applying a beam network constraint that penalizes a difference between the network of beams and the shape boundary representation. The iteratively modifying can include performing an iterative topology optimization process and increasing a weight of the beam network constraint at least at an end portion of the iterative topology optimization process.

The beam network constraint can include: a normalization factor that depends on a volume of the design space and on a characteristic size; and a fall-off function that limits an influence of the beam network constraint. The fall-off function can be a smoothed Heaviside function that limits the influence of the beam network constraint up to a predetermined distance away from the network of beams. The beam network constraint can be approximated using a shape-differentiable constraint.

The iteratively modifying can include iteratively: performing a shape gradient descent until convergence using a function that combines a topology optimization objective function and one or more constraints, wherein the one or more constraints can include the shape-differentiable constraint; and updating respective penalty parameters of the one or more constraints. Each of the penalty parameters of the one or more constraints can be initialized using a constraint-specific weight, a shape gradient of the respective constraint, and a shape gradient of the objective function.

One or more beams can be assigned a non-circular cross-section. The generating can include: determining locally optimal orientations for each of the one or more beams using i) a shape of the first three-dimensional shape along a respective edge of the graph, or ii) directions of forces acting on each of the one or more beams, the directions of forces determined from force fields for the first three-dimensional shape.

Generating the second three-dimensional shape from the graph can include generating each of the beams of the network of beams from a respective edge of the graph, wherein each of the beams can be a curved beam generated by fitting a curve to approximate a medial axis of a portion of the first 3D shape for each respective edge of the graph.

One or more aspects of the subject matter described in this specification can be embodied in one or more methods (and also one or more non-transitory computer-readable mediums tangibly encoding a computer program operable to cause one or more processors to perform operations), including: obtaining, by a computer aided design program, a design space for a modeled object, for which a corresponding physical structure is to be manufactured, and one or more design criteria for the modeled object; determining, based on the one or more design criteria, a topology optimization objective function and one or more constraints; determining a function to be minimized, wherein the function combines the topology optimization objective function and the one or more constraints, the function comprising a penalty parameter for each of the one or more constraints; initializing each of the penalty parameters for the one or more constraints using a constraint-specific weight, a shape gradient of the respective constraint, and a shape gradient of the objective function; minimizing the function, wherein minimizing the function includes adaptively updating the penalty parameters until convergence to obtain a shape of the modeled object that minimizes the function and satisfies the one or more design criteria; and providing, by the computer aided design program, the shape of the modeled object for use in manufacturing the physical structure using one or more computer-controlled manufacturing systems.

One or more aspects of the subject matter described in this specification can also be embodied in one or more systems including one or more processors; and a computer-readable medium storing instructions that cause the one or more processors to perform operations including: obtaining, by a computer aided design program, a design space for a modeled object, for which a corresponding physical structure is to be manufactured, and one or more design criteria for the modeled object; determining, based on the one or more design criteria, a topology optimization objective function and one or more constraints; determining a function to be minimized, wherein the function combines the topology optimization objective function and the one or more constraints, the function comprising a penalty parameter for each of the one or more constraints; initializing each of the penalty parameters for the one or more constraints using a constraint-specific weight, a shape gradient of the respective constraint, and a shape gradient of the objective function; minimizing the function, wherein minimizing the function includes adaptively updating the penalty parameters until convergence to obtain a shape of the modeled object that minimizes the function and satisfies the one or more design criteria; and providing, by the computer aided design program, the shape of the modeled object for use in manufacturing the physical structure using one or more computer-controlled manufacturing systems.

Particular embodiments of the subject matter described in this specification can be implemented to realize one or more of the following advantages. The described methods can be employed during topology optimization of a modelled object (e.g., for automatically generating at least a portion of a physical structure to be manufactured) to generate designs that satisfy predetermined structural objectives and constraints, while being guided by a predefined shape-type requirement for the structure, such as a structure composed of a network of beams. This can facilitate construction of the modelled object, especially for larger frame structures, such as bridges. The described methods can use two different representations of the three-dimensional shape of a modelled object and use the advantages of each of the two different representations. The two representations of the object/structure, e.g., an idealized beam network and a continuum representation, can co-evolve during the optimization process. A constraint can be imposed to drive the two representations to converge. The described methods can be used to enforce manufacturability of the physical structure.

Further, the described methods can be applied to fluid channel optimization paradigms or other physics domains, e.g., thermal, multiphysics, etc.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of a system usable to facilitate computer aided design and manufacturing of structures such as networks of beams.

FIG. 2 is a flowchart of an example of a process for topology optimization.

FIGS. 3A-3D shows examples of different stages of a process for topology optimization.

FIG. 4 is a flowchart of an example of a process for forming a shape of a predefined shape-type.

FIGS. 5A-5D shows an example of an extraction of a graph and generation of a 3D shape from the graph.

FIG. 6 is a flowchart of a process for topology optimization.

FIGS. 7A-7C shows an example of a topology optimization of a footbridge structure.

FIGS. 8A-8D show examples of topology optimization of an L-bracket according to different design objectives.

FIG. 9 is a flowchart of a process for topology optimization including an initialization of penalty parameters.

FIGS. 10A-10F show an example of an influence function and of its effect on the process for topology optimization.

FIG. 11 is a schematic diagram of a data processing system including a data processing apparatus, which can be programmed as a client or as a server, and implement the techniques described in this document.

Like reference numbers and designations in the various drawings indicate like elements.

### DETAILED DESCRIPTION

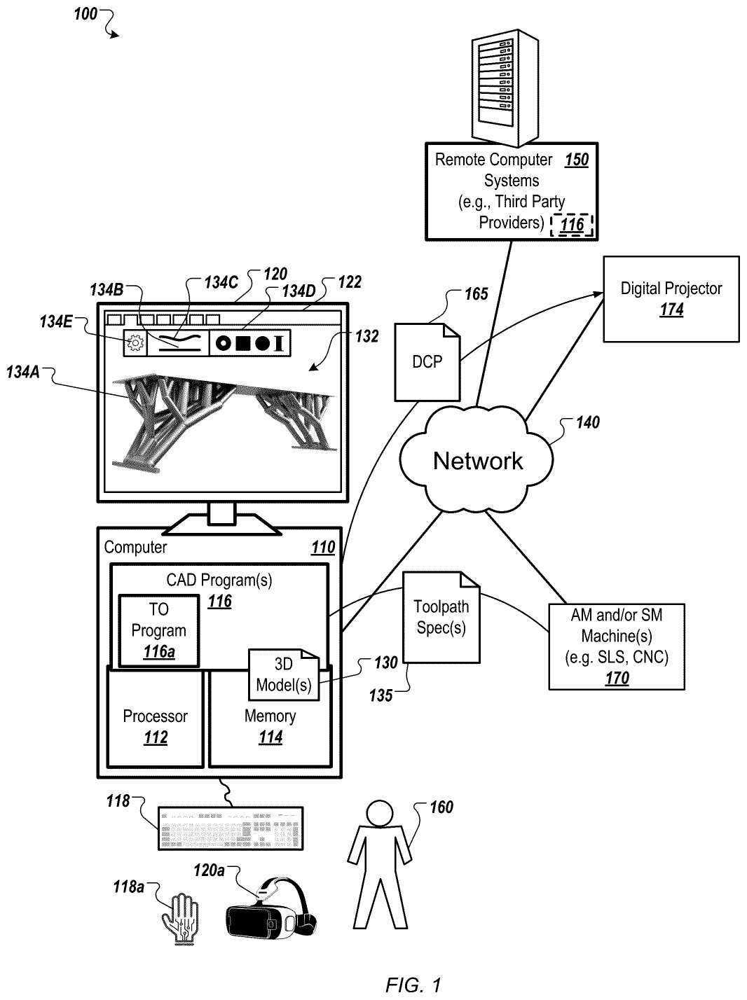

FIG. 1 shows an example of a system 100 usable to facilitate computer aided design and manufacturing of structures such as connected beam structures. A computer 110 includes a processor 112 and a memory 114, and the computer 110 can be connected to a network 140, which can be a private network, a public network, a virtual private network, etc. The processor 112 can be one or more hardware processors, which can each include multiple processor cores. The memory 114 can include both volatile and non-volatile memory, such as Random Access Memory (RAM) and Flash RAM. The computer 110 can include various types of computer storage media and devices, which can include the memory 114, to store instructions of programs that run on the processor 112, including Computer Aided Design (CAD) program(s) 116, which includes a topology optimization program 116a, such as a topology optimization program that generates an optimized beam network structure using a boundary-based or density-based representation and a graph extracted from the boundary-based or density-based representation as described.

In some instances, the numerical simulation performed by the systems and techniques described in this document can simulate one or more physical properties and can use one or more types of simulation to produce a numerical assessment of a physical response (e.g., structural response) of the modeled object. For example, finite element analysis (FEA), including linear static FEA, finite difference method(s), and material point method(s) can be used. Further, the simulation of physical properties can include Computational Fluid Dynamics (CFD), Acoustics/Noise Control, thermal conduction, computational injection molding, electric or electro-magnetic flux, and/or material solidification (which is useful for phase changes in molding processes) simulations.

As used herein, CAD refers to any suitable program used to design physical structures that meet design requirements, regardless of whether or not the program is capable of interfacing with and/or controlling manufacturing equipment. Thus, CAD program(s) 116 can include Computer Aided Engineering (CAE) program(s), Computer Aided Manufacturing (CAM) program(s), etc. The program(s) 116 can run locally on computer 110, remotely on a computer of one or more remote computer systems 150 (e.g., one or more third party providers' one or more server systems accessible by the computer 110 via the network 140) or both locally and remotely. Thus, a CAD program 116 can be two or more programs that operate cooperatively on two or more separate computer processors in that one or more programs 116 operating locally at computer 110 can offload processing operations (e.g., geometry generation and/or physical simulation operations) “to the cloud” by having one or more programs 116 on one or more computers 150 perform the offloaded processing operations. In some implementations, all geometry generation operations are run by one or more programs in the cloud and not in a geometry representation modeler (e.g., B-Rep modeler) that runs on the local computer. Moreover, in some implementations, the geometry generation program(s) can be run in the cloud from an Application Program Interface (API) that is called by a program, without user input through a graphical user interface.

The CAD program(s) 116 present a user interface (UI) 122 on a display device 120 of the computer 110, which can be operated using one or more input devices 118 of the computer 110 (e.g., keyboard and mouse). Note that while shown as separate devices in FIG. 1, the display device 120 and/or input devices 118 can also be integrated with each other and/or with the computer 110, such as in a tablet computer (e.g., a touch screen can be an input/output device 118, 120). Moreover, the computer 110 can include or be part of a virtual reality (VR) and/or augmented reality (AR) system. For example, the input/output devices 118, and 120 can include VR/AR input controllers, gloves, or other hand manipulating tools 118a, and/or a VR/AR headset 120a. In some instances, the input/output devices can include hand-tracking devices that are based on sensors that track movement and recreate interaction as if performed with a physical input device. In some implementations, VR and/or AR devices can be standalone devices that may not need to be connected to the computer 110. The VR and/or AR devices can be standalone devices that have processing capabilities and/or an integrated computer such as the computer 110, for example, with input/output hardware components such as controllers, sensors, detectors, etc.

In any case, a user 160 interacts with the CAD program(s) 116 to generate and/or optimize 3D model(s), which can be stored in model document(s) 130. In the example shown in FIG. 1, a 3D model 132 includes geometry 134A that has been automatically generated using a process that employs systems and techniques described in this document. The topology generation process can receive an initial 3D design space as input. In some implementations, the user can select an initial geometry for topology optimization which includes one or more keep in and/or keep out regions. In some implementations, boundary constraints can be defined with respect to such keep-in regions.

In some implementations, the user 160 can define a topology optimization problem to produce a desired 3D model from a starting domain. In general, the input design space can be automatically generated or user specified.

The CAD program(s) 116 can implement at least one topology optimization process 116a to obtain an optimized shape for a modeled object for which a corresponding physical structure is to be manufactured, such as an optimized network of beams, which enables the CAD program(s) 116 to generate the 3D model(s) automatically based on design objective(s) and constraint(s), i.e., design criteria, where the geometric design can be iteratively optimized based on simulation feedback (e.g., based on a numerical, physics simulation). In some instances, multiple 3D models can be co-created by one or more generative design processes and can be assembled to form a new 3D model. Note that, as used herein, “optimization” (or “optimum”) does not mean that the best of all possible designs is achieved in all cases, but rather, that a best (or near to best) design is selected from a finite set of possible designs that can be generated within an allotted time, given the available processing resources.

The design criteria can be defined by the user 160, or by another party and imported into the CAD program(s) 116. The design criteria can include a geometric objective that drives the topology evolution using an iterative numerical simulation process, with or without physics/physical response simulations. The design criteria can also include physics objectives for the evolution of the structure of the 3D model. For example, a geometric objective can correspond to a physical response of the 3D model. In some instances, the boundary conditions can be pressure, displacement, force, displacement and/or velocity boundary conditions. In some implementations, the design criteria can include structural integrity constraints for individual parts (e.g., a requirement that a part should not fail under the expected structural loading during use of the part) and physical constraints imposed by a larger system (e.g., a requirement that a part be contained within a specified volume so as not to interfere with other part(s) in a system during use).

In topology optimization, the optimum distribution of material can be determined by minimizing an objective function subject to design constraints (e.g., structural compliance with volume as a constraint). Density-based approaches discretize the volume of the part, and assign a density to each discrete cell. Then, the densities are driven toward solid and empty while minimizing the objective(s) subject to the constraints. Boundary-based approaches instead track the shape of the external interface of the solid part and move the boundary such that the constraints are satisfied and the objective(s) are minimized, such as in a level set method.

In some implementations, a 3D shape of the modeled object has a level set representation. A level set representation method can be used to track the boundary of the shape Ω of the modeled object during topology optimization. This has the advantages of providing precise knowledge of the boundary, and allowing topological changes as the surface evolves without the need for re-meshing. In any case, note that the topology optimization process can (and often will) be done using a different representation of geometry than that employed by the CAD program(s) 116 for 3D modelling. For example, the CAD program(s) 116 can use a B-Rep model for the input geometry, while the geometry generation engine (e.g., in CAD program(s) 116) can employ a level set function embedded in a voxel or tetrahedral mesh, in addition to a second model of the object, such as a beam network structure composed of geometric primitives.

The topology optimization program 116a can use a level set-based topology optimization along with a graph representation extracted from a skeleton of the level set. This graph can be used to create a different 3D shape representation of the modeled object, e.g., a network of beams. The level set and the network of beams can co-evolve during the optimization. A constraint can be used to move the level set geometry closer to the extracted beam network and to drive the two representations to converge. The graph representation can be used to enforce manufacturability in the beam network.

The user 160 or a program can select a type of beams used by the topology optimization program 116a to generate a beam structure. For example, the user 160 or a program can set the cross-section of the beam 134D to be circular. The beams can be hollow or solid beams. Other cross-section shapes can be used, e.g., square beams, I-beams, etc. The beams can be straight beams 134B or curved beams 134D (e.g., the beams can be generated using B-splines.) The user can also determine other settings 134E for the topology optimization program 134E. For example, the user 160 or a program can set 134E whether the curved beams are generated using geometric or structural considerations. The user 160 or a program can set 134E whether each beam has a constant cross-section or whether cross-section variations are allowed along a beam, e.g., beams that are frustums.

Once the topology optimization process has finished and the user 160 is satisfied with the algorithmically designed model 132, the computer model 132 can be stored as a model document 130 and/or used to generate another representation of the model (e.g., toolpath specifications for a manufacturing process for the structure or portions thereof). This can be done upon request by the user 160, or in light of the user's request for another action, such as sending the computer model 132 to a manufacturing machine, e.g., additive manufacturing (AM) machine(s) and/or subtractive manufacturing (SM) machine(s) 170, or other manufacturing machinery, which can be directly connected to the computer 110, or connected via a network 140, as shown. This can involve a post-process carried out on the local computer 110 or externally, for example, based on invoking a cloud service running in the cloud, to further process the generated 3D model (e.g., based on considerations associated with the additive manufacturing process) and to export the 3D model to an electronic document from which to manufacture. Note that an electronic document (which for brevity will simply be referred to as a document) can be a file, but does not necessarily correspond to a file. A document may be stored in a portion of a file that holds other documents, in a single file dedicated to the document in question, or in multiple coordinated files. In addition, the user 160 can save or transmit the 3D model for later use. For example, the CAD program(s) 116 can store the document 130 that includes the algorithmically designed model 132.

The CAD program(s) 116 can provide a document 135 (e.g., having toolpath specifications of an appropriate format) to an AM and/or SM machine 170 to produce a physical structure corresponding to at least a portion of the algorithmically designed model 132. An AM machine 170 can employ one or more additive manufacturing techniques, such as granular techniques (e.g., Powder Bed Fusion (PBF), Selective Laser Sintering (SLS) and Direct Metal Laser Sintering (DMLS)) or extrusion techniques (e.g., Fused Filament Fabrication (FFF), metals deposition). In some cases, the AM machine 170 builds the physical structure directly, and in some cases, the AM machine 170 builds a mold for use in casting or forging the physical structure.

A SM machine 170 can be a Computer Numerical Control (CNC) milling machine, such as a multi-axis, multi-tool milling machine used in the manufacturing process. For example, the CAD program(s) 116 can generate CNC instructions for a machine tool system 170 that includes multiple tools (e.g., solid carbide round tools of different sizes and shapes, and insert tools of different sizes that receive metal inserts to create different cutting surfaces) useable for various machining operations. Thus, in some implementations, the CAD program(s) 116 can provide a corresponding document 135 (having toolpath specifications of an appropriate format, e.g., a CNC numerical control (NC) program) to the SM machine 170 for use in manufacturing the physical structure using various cutting tools, etc.

In addition, in some implementation, no physical manufacturing is involved. The systems and techniques described herein are applicable to any suitable 3D modelling software. Thus, in some implementations, the CAD program(s) 116 can be animation production program(s) that render the 3D model 132 to a document 165 of an appropriate format for visual display, such as by a digital projector 174 (e.g., a digital cinema package (DCP) 165 for movie distribution) or other high resolution display device. Other applications are also possible.

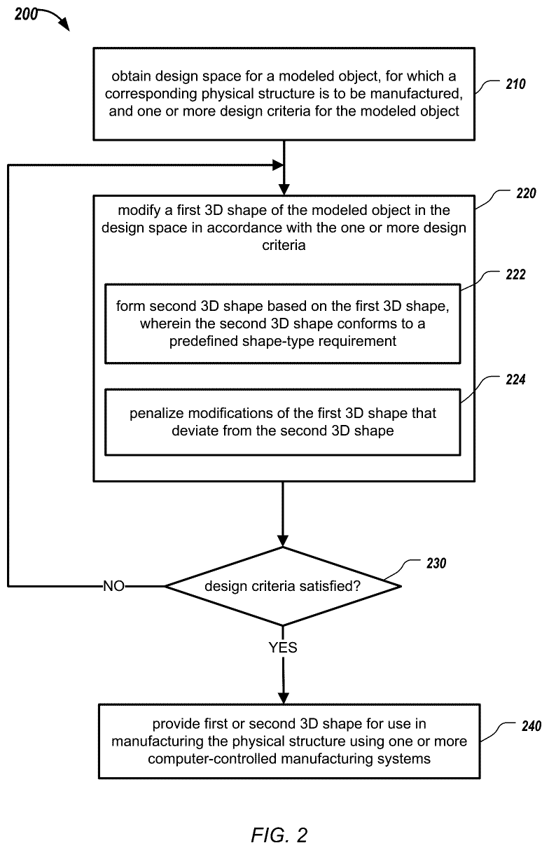

FIG. 2 is a flowchart of an example of a process 200 for topology optimization. A design space for a 3D modeled object for which a corresponding physical structure is to be manufactured and one or more design criteria can be obtained 210, e.g., by CAD program(s) 116, for use in producing a 3D model. The design space for a 3D modelled object is the volume inside which the part is to be designed. The design space can include a bounding volume containing an initial specification of one or more outer shapes of the 3D topology for the object. The design space can include 3D model(s), designed in or loaded into the CAD program(s) 116, that serve as a sub-space of an optimization domain of a described topology optimization process, and/or a set of input regions, e.g., keep-out regions where no geometry is to be generated and/or keep-in regions, used to specify boundary conditions for topology optimization. The keep-in and/or keep-out regions can be, e.g., defined or selected by a user through a user interface, such as the UI 122.

The design criteria can include design objective(s) and design constraint(s) for the object. Design objectives can include but are not limited to minimizing waste material, minimizing the weight of the part, and minimizing the compliance, stress, or other intrinsic property of the part. Though not required, it is typical for a design objective to be rooted in a simulation (linear static, fluid dynamic, electromagnetic, etc.) of the design. Design constraints can include a variety of geometric and physical characteristics or behaviors that should be met in any generated design (requirements either on individual parts or on the entire assembly are also admissible); examples include maximum mass, maximum deflection under load, maximum stress, fixed mass, fixed volume, etc.

Topology optimization can be performed. Topology optimization includes modifying both a geometry of the 3D shape and a topology of the 3D shape (e.g., adding/removing holes or voids to modify the spatial properties of the surface, thus changing how shape elements are bounded and connected in the 3D model).

A first 3D shape of the modeled object can be iteratively modified 220 in the design space in accordance with the one or more design criteria. The first 3D shape can be any representation of the shape Ω of the modeled object. For example, the first 3D shape can include a density-based representation. The boundary can be estimated using an iso-contour of the densities. In some examples, a boundary-based representation is used. For example, the first 3D shape can be a level set representation ϕΩ. A signed distance field is an example of such a level set function ϕΩ, where the zero-contour (zero-sublevel set) represents the shape boundary, positive values of the function correspond to points exterior to the material domain and quantify the distance between the point and the nearest domain surface, and negative values correspond to points interior to the material domain and quantify the distance between the point and the nearest domain surface. In a level set-based topology optimization method, the outer shape of a structure is represented by a contour of the level set function, and a change in shape and configuration is represented by a change in the level set function values.

An advantage of using a boundary-based (e.g., level set) or a density-based representation for topology optimization methods is that the geometric initialization is simple. A uniform allocation of material across a design domain is usually sufficient to begin an optimization that will produce a meaningful design. In addition, topology changes are built-in and occur as cells in the grid (e.g., voxels) are reduced to empty. However, since material can be placed anywhere in the grid, implementations based on continuum topology optimization methods can generate optimal but also highly free-form geometries.

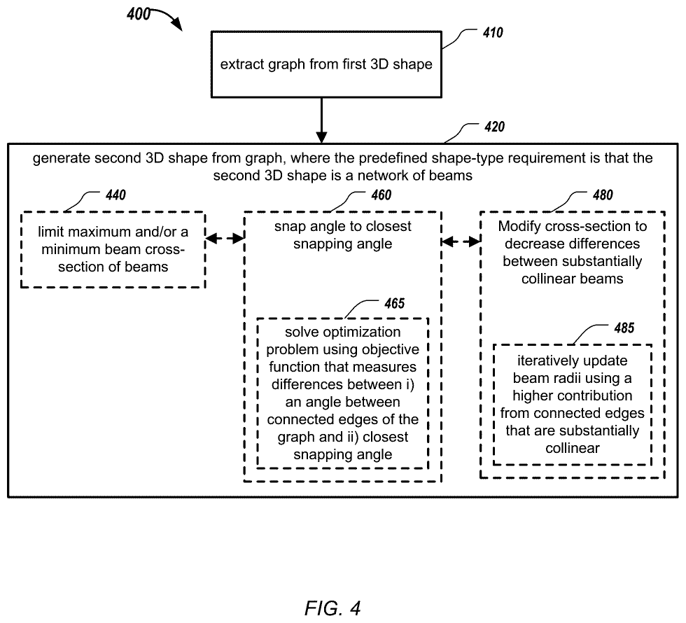

Iteratively modifying 220 can include forming 222 a second 3D shape based on the first 3D shape. The second 3D shape can conform to a predefined shape-type requirement. For example, the shape-type requirement can include that the second 3D shape is a network of beams. Further, the shape-type requirement can include that one or more beams of the network of beams are straight beams. The shape type requirement can include that one or more beams of the network of beams are curved beams, e.g., such that a length profile of the beam corresponds to a B-spline. The shape-type requirement can include the type of cross-section of one or more beams. For example, the beams can have a circular cross-section. The beams can also be I-beams, square beams, or have any other cross-section. The beams can be solid or hollow beams. The cross-section can be constant or variable along a beam, and the dimension(s) of each beam cross-section can vary along the length of the beam. For example, a beam can have a taper length profile, e.g., the cross-sectional dimension(s) of each beam can smoothly change from a minimum beam dimension (e.g., a minimum radius) to a maximum beam dimension (e.g., a maximum beam radius). FIG. 4 is a flowchart of an example of a process 400 that can be used to form 222 the second 3D shape based on the first 3D shape. An advantage of using structures such as beam networks to perform topology optimization is that the resulting geometry is composed of the desired primitives and it is simple to enforce constraints, such as manufacturability constraints, on the primitives and their connections.

Iteratively modifying the first 3D shape can also include penalizing 224 modifications of the first 3D shape that deviate from the second 3D shape. For example, if the second 3D shape is a beam network, a beam network constraint can be imposed to penalize modifications of the first 3D shape that deviate from the formed beam network so that the first 3D shape is forced to conform to the beam network and any non-beam like structures are suppressed. The first 3D shape can be iteratively modified until the design criteria are satisfied 230. When the design criteria are satisfied 230, the first or second 3D shape can be provided 240 for use in manufacturing the physical structure using one or more computer-controlled manufacturing systems.

In each topology optimization iteration of process 200, the first 3D shape is modified so that it evolves toward the second 3D shape. The second 3D shape is formed based on the first 3D shape so no special geometry initialization of the second 3D shape is needed. The second 3D shape is periodically updated (i.e., reformed) during the optimization (e.g., after some fixed or changeable number of iterations), thus allowing for a co-evolution of the first shape (e.g., a level set geometry) and the second 3D shape (e.g. an idealized beam structure) during the optimization process.

The method of FIG. 2 can use the advantages of a continuum topology optimization method but can also generate a model of a physical structure that is easy to import and edit in a CAD software and easy to manufacture. Since the second shape is explicitly tracked during the optimization, additional manufacturing constraints can be incorporated into the optimization. For example, if the second shape is a beam network, manufacturing constraints such as minimum and maximum cross-section sizing, conditions on the angles between beams connected at joints, and continuity along cross-sections can be incorporated into the optimization. Further, since the beam network is explicitly represented, it can be exported as a set of editable primitives that can easily be edited in a CAD tool, rather than having to edit or convert a dense mesh.

The process of FIG. 2 can provide, e.g., by CAD program(s) 116, the model of the object with the synthesized shape and/or topology for use in manufacturing a physical structure. The providing can involve sending or saving the 3D model to a permanent storage device for use in manufacturing the physical structure corresponding to the object using manufacturing systems. In some implementations, the providing can involve generating, e.g., by CAD program(s) 116, toolpath specifications for computer-controlled manufacturing system(s) using the computer model, and manufacturing, e.g., by CAD program(s) 116, at least a portion of the modeled object corresponding to the physical to be manufactured with the computer-controlled manufacturing system(s) using the toolpath specifications. In some implementations, the providing can include manufacturing a physical structure with a manufacturing machine using the toolpath specification generated, where the computer model can be a model of the physical structure that will be manufactured using a subtractive manufacturing process. The computer model that is provided can be the computer model produced by the topology optimization method or a post-processed version of the output of such.

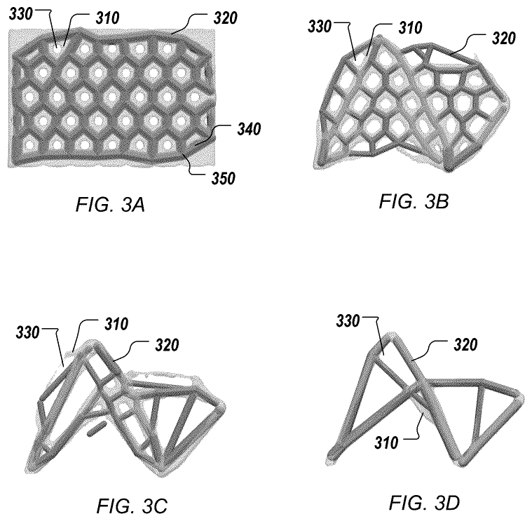

FIGS. 3A-3D show examples of different stages of the evolution of an example of a first 3D shape 310 and an example of a second 3D shape 320 co-evolving during an optimization process such as process 200. In the example of FIGS. 3A-3D, the first 3D shape is a level set representation 310 generated by filling a design space with occupied elements and empty holes 330. In the example of FIGS. 3A-3D, the second 3D shape 320 is a beam network made of idealized cylindrical beams 340 connected by joints 350. FIGS. 3A-3D correspond to snapshots of the shape co-evolution of the level set 310 and the idealized beam network 320. No special initialization of the beam network 320 is needed. The beam network 320 is extracted from the level set representation 310 during the optimization process and its topology and connectivity evolves along with the level set geometry, taking advantage of the features of the continuum topology optimization method. At the same time, as shown in FIG. 3D the level set shape is eventually forced to conform to the beam network and non-beam structures are suppressed.

FIG. 4 is a flowchart of an example of a process 400 for forming 222 a second 3D shape of a predefined shape-type based on the first 3D shape. A graph can be extracted 410 from the first 3D shape. The second 3D shape can be generated 420 from the graph. The predefined shape-type requirement can be that the second 3D shape is a network of beams. The first step is to extract a beam network from Ω, beam (Ω). This involves finding a collection of regular primitives (and user-specified geometry) whose union best approximates Ω. Optionally, this beam network beam (Ω) can be modified 440, 460, 480 to account for the manufacturability of the beam network.

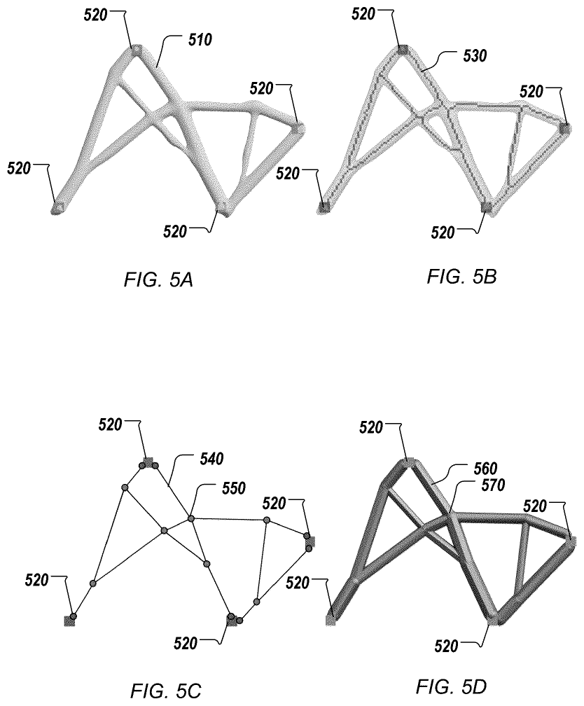

FIGS. 5A-5D show different stages of an example process of beam network extraction. The construction of the beam network beam (Ω) proceeds in two steps. First, a representation of the beam network as a graph (FIG. 5C) is derived. The nodes 550 of the graph correspond to the junctions 570 of the beam network, while the edges 540 represent the individual beams 560. This graph can be obtained by applying a medial axis transform on Ω 510 to obtain the skeleton 530, which is the centerline that runs through the interior of the shape. Since the user or a program can specify arbitrarily shaped regions of Ω that will be excluded from the beam representation (keep-out regions), the method ensures that the skeleton is connected to each of these regions via an endpoint of the skeleton. The result is a connected set of single-width voxels between junctions and endpoints (FIG. 5B) that can be configured to fit with other user geometry. The skeleton voxels can be classified into three categories based on the 3×3×3 neighborhood: junctions are defined as skeleton voxels with more than two neighbors, endpoints are defined as skeleton voxels with a single neighbor, and slabs are skeleton voxels with exactly two neighbors. The center voxel of each junction as well as any endpoint voxels can be used to form the nodes of the graph representation. Edges are placed along the connecting lines of voxels (FIG. 5C) by traversing from each node through the slab skeleton voxels using e.g., a breadth-first traversal until the other junctions or endpoints are found.

This graph matches the topology of the geometry but the junction voxels sometimes do not precisely lie along linear fits to the edge voxels since the skeletonization algorithm only yields an approximate medial axis. In order to match the edges, a refinement step can be performed where the coordinates of the junctions are updated using a few

$${\sum }_{j = 1}^{m} \frac{1}{n} {\sum }_{i = 1}^{n} \frac{{‖ {x}_{i} - {p}_{j} ( {x}_{i} ) ‖}^{2}}{{σ}^{2} - {‖ {x}_{i} - {p}_{j} ( {x}_{i} ) ‖}^{2}}$$

iterations of gradient descent. For example, a Geman-McClure M-estimator can be used as the objective since it minimizes the distance of each edge converging at a junction to its respective skeleton voxels, while being robust to outliers.

Here m is the number of edges at the junction, n is the number of skeleton voxels corresponding to the j^{th} edge, and pⱼ(xᵢ) is the projection of xᵢ onto the line through edge j and σ is a constant that controls the contribution of voxels that are far from the edge. For example, σ=1 can be used.

The geometry of the edges can be fit with curved or other complex geometry. In some examples, one or more beams are curved beams generated by fitting a curve to approximate a medial axis of a portion of the first 3D shape for each respective edge of the graph. For example, for every edge in the graph, a B-Spline or another curve can be fit to approximate the portion of the skeleton corresponding to that edge.

In the example of FIG. 5D, each edge 560 is modeled as a straight cylindrical beam of uniform radius. For every edge in the graph, the end-points of the beam are set to lie at the appropriate graph junctions 550, and then for each voxel associated with the edge, its value in the signed distance field ϕ(Ω) of Ω is sampled. The radius of the beam, r, can be set to

$$r \frac{1}{n} {\sum }_{i = 1}^{n} - {ϕ}_{Ω} ( {x}_{i} ) + 𝓏 ,$$

where xᵢ is one of the n voxels associated with the beam and z is a constant offset that can be determined experimentally since the voxels do not lie exactly on the medial axis. For example, z can be set to 0.8 dx, where dx denotes the length of a voxel. The idealized beam network associated with Ω is the union beam (Ω) of all the individual beams identified above. A signed distance field of beam (Ω) can be constructed. Given a beam j in the beam network graph, the endpoints and radius can be used to generate a signed distance field ϕ^{j}_{b} of a hemisphere-capped cylinder that represents the beam. A Boolean union of the individual beams can be used for the signed distance function of the beam network as ϕ_{beam(Ω)}(x):=min{ϕ_{b}^{e}(x): e∈E} where E is the set of edges in the beam network graph (FIG. 5D). This approach applies no explicit modeling of the junctions, which simply form naturally from the union of all the intersecting beams.

Regions of the shape marked with squares 520 in FIGS. 5A-5D are regions where boundary conditions are defined (keep-in regions) and are to be kept in the final resulting beam network (FIG. 5D).

Referring again to FIG. 4, manufacturability requirements of the formed beam network can optionally be enforced 440, 460, 480. Various modifications can be made to the beams making up beam (Ω), and thus leading to modifications of ϕ_{beam(Ω)}. For example, a limit maximum and/or a minimum beam cross-section of beams can be imposed 440. When manufacturing a beam-based structure there are typically limits on the cross-section sizes available. These type of constraints can be enforced by limiting the maximum and minimum cross-section sizes of the idealized beams used to construct ϕ_{beam(Ω)}. If the beam cross-section is circular, the maximum and minimum radii can be limited.

A manufacturability requirement can also be imposed on the junctions. An angle between two edges of the graph can be snapped 460 to a closest snapping angle. For example, angles between neighboring beams at a junction can be snapped when they are close to a specified angle such as multiples of 15°, 30°, 45°, or 90°. Having junctions with regular angles allows off-the-shelf parts to be used or repeated use of a custom cast junction, thus saving manufacturing costs.

Angle snapping can be performed by solving 465 an optimization problem using an objective function that measures differences between i) an angle between connected edges of the graph and ii) a closest snapping angle. Nodal positions of the graph can be iteratively updated. Given a target snapping angle θₜ∈[1,π], the objective function can measure the difference between the current angle and the closest angle to snap to for every connected pair of edges. The energy can be defined as

$${min {\sum }_{{e}_{i} ∈ E} {\sum }_{{e}_{j} ∈ 𝒩 ( {e}_{i} )} ( 〈 \frac{{e}_{i}}{‖ {e}_{i} ‖} , \frac{{e}_{j}}{‖ {e}_{j} ‖} 〉 ) - cos ( {\hat{θ}}_{ij} ) )}^{2} ,$$

where E is the set of all edges in the graph, and \tilde{θ}ᵢⱼ is a multiple k×θₜ (where k is an integer) closest to the current angle ∠(eᵢ, eₜ) if it is within a threshold, and ∠(eᵢ, eₜ) otherwise. For example, the threshold can be set to 0.1×θₜ. The minimization can be performed using a gradient descent.

A manufacturability requirement can also be imposed 480 to beams that are almost collinear. The cross-sections can be modified 480 to decrease differences between substantially collinear beams (i.e., where the angle between the edges approaches 180°.)

When combined with the angle snapping, process 480 enables “T-junction” structures, where the two edges can be replaced with a single standard beam when the physical structure is manufactured. As a result, this can significantly reduce material and construction costs. This method 480 also produces geometry that appears more natural and clean. The cross-section continuity is an iterative smoothing problem considering the target radii of the idealized beams. For example, the method can iteratively update 485 beam radii using a higher contribution from connected edges that are substantially collinear, as follows

$${r}_{i} ← {r}_{i} + η ( - {W}_{i} {r}_{i} + \frac{1}{{W}_{i}} {\sum }_{{e}_{j} ∈ 𝒩 ( {e}_{i} )} {r}_{j} σ ( 〈 \frac{{e}_{i}}{‖ {e}_{i} ‖} , \frac{{e}_{j}}{‖ {e}_{j} ‖} 〉 ) )$$

where rᵢ denotes the radius of a beam corresponding to the edge eᵢ∈E in the graph. rᵢ can be iteratively updated while considering the angle between the edge eᵢ and all its neighbors {eⱼ∈N(eᵢ)}.

This update equation is reminiscent of Laplacian smoothing, except that the weights Wᵢ can be chosen such that the most influence comes from neighboring edges that are almost collinear to the current edge. The logistic sigmoid function σ can be used to compute the weights in range [0,1]

$$σ ( x ) = \frac{m}{1 + {e}^{k ( x - {x}_{0} )}} ,$$

where m is a parameter that denotes the maximum value of the function, k controls the steepness of the function, and x₀ controls where the midpoint of the function lies. For example m=0.5, k=50, and x₀=−0.9 can be set so that the function output rapidly drops as the dot product of neighboring edges goes above −0.9 (<155° approximately).

Wᵢ is the sum of weights computed from all the neighboring edges of eᵢ:

$${W}_{i} {\sum }_{{e}_{j} ∈ 𝒩 ( {e}_{i} )} σ ( 〈 \frac{{e}_{i}}{‖ {e}_{i} ‖} , \frac{{e}_{j}}{‖ {e}_{j} ‖} 〉 ) )$$

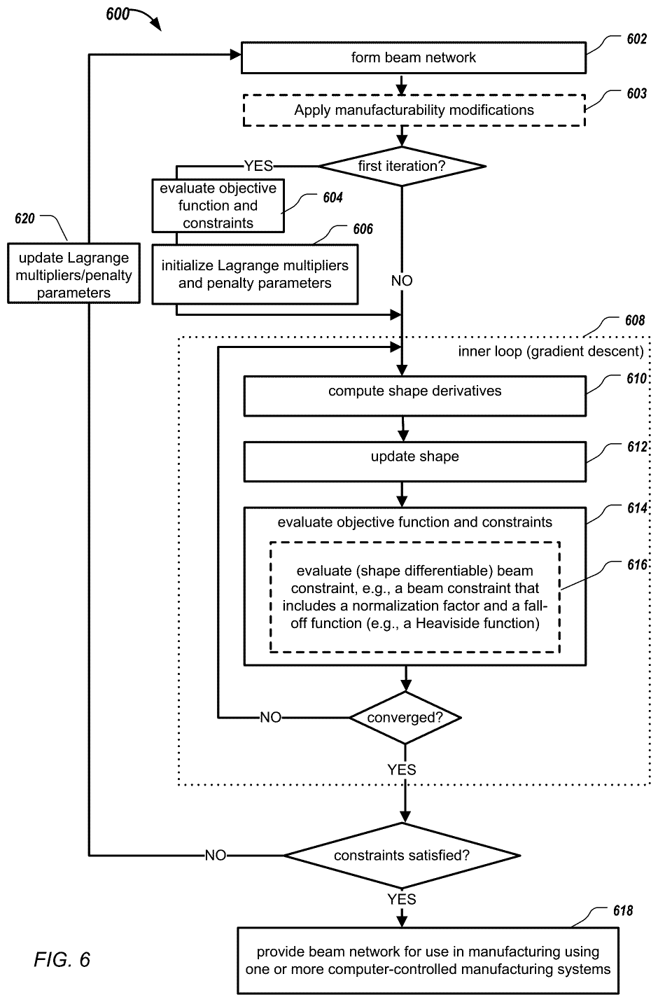

FIG. 6 is a flowchart of an example of a process 600 for topology optimization. Process 600 is a particular example of process 200. In summary, process 600 searches for an optimal shape Ω* that minimizes an objective F(Ω) subject to a set of equality constraints Gᵢ(Ω):

$${min}_{Ω} \qquad ℱ ( Ω )$$

$$\begin{matrix}s . t . & 𝒢 ( Ω )\end{matrix} = 0 ∀ i = 1 , … , k$$

As described in further detail below, a level set-based topology optimization can be used with an augmented Lagrangian algorithm to solve the above optimization problem. A shape Ω is represented as the zero-sublevel set of a piecewise smooth level set function ϕ defined implicitly on the background grid. Thus Ω:={x: ϕ(x)≤0}. The function ϕ is updated in each iteration in order to improve the optimization objective F and reduce the constraint violation until a feasible, locally optimal shape is achieved. This is done by alternating between two procedures. The first procedure is to perform shape gradient descent on the augmented Lagrangian shape function (“inner loop”), which is an algebraic combination of the objective and constraint functions,

$$ℒ ( Ω ) := ℱ ( Ω ) + {\sum }_{i} {μ}_{i} {𝒢}_{i} ( Ω ) + {\sum }_{i} \frac{{c}_{i}}{2} {( {𝒢}_{i} ( Ω ) )}^{2}$$

where μᵢ hare the Lagrange multipliers and cᵢ are the penalty parameters. The second procedure is to adaptively update the Lagrange multipliers and penalty parameters (“outer loop”). After alternating between these two procedures, the shape converges within tolerance to a locally optimal, feasible solution of the optimization problem. To update the level set function of the shape (inner loop), in each iteration, a standard level set Hamilton-Jacobi equation can be solved for a well-chosen normal speed function v and pseudo-time ε, and initialized at the current level set function ϕ. The normal speed function can be chosen to be a descent direction for the augmented Lagrangian.

A constraint function G_{beam} can be added to the level set-based topology optimization problem to penalize shapes that do not conform to an idealized beam network. By driving the value of this shape constraint function to zero (subject to a tolerance) during the course of the optimization means that the converged shape Ω* will conform to a beam network. The resulting shape can be edited in a standard CAD system and can be easily manufactured using standard methods, such as welding or bolting extrusions together.

For example, process 600 can solve the above optimization problem for a structural compliance objective subject to a volume constraint Gᵥₒₗ(Ω)=0 and the beam constraint G_{beam}(Ω)=0. The structural compliance of Ω with respect to a given load case is

$$ℱ ( Ω ) := {\int }_{Ω} σ ( {u}_{Ω} ) : e ( {u}_{Ω} )$$

where σ(u_{Ω}) and e(u_{Ω}) are respectively the stress and strain tensors of the displacement u_{Ω}. This satisfies the linear elasto-static problem

−div(σ(u_{Ω}))=f in Ω

u_{Ω}=0 on Γ_{D}

n·σ(u_{Ω})=g on Γ_{N}

n·σ(u_{Ω)=}0 on ∂Ω\(Γ_{D}∪Γ_{N}),

where f is the prescribed body load, g is the prescribed surface traction (Neumann boundary condition) on region Γ_{N} of the boundary ∂Ω, and fixity (Dirichlet boundary condition) is prescribed on region Γ_{D} of the boundary ∂Ω.

The volume constraint can be defined as

$${𝒢}_{vol} ( Ω ) := {\int }_{Ω} 1 - {V}_{targ}$$

where V_{targ} is a target volume fraction. The beam constraint is described in further detail below.

Process 600 performs an Augmented Lagrangian Optimization of the above structural problem using a compliance objective with a volume constraint and the beam constraint. At the start of the optimization the beam network is formed 602 (i.e., extracted from the current 3D model). Optionally, manufacturability modifications are applied 603.

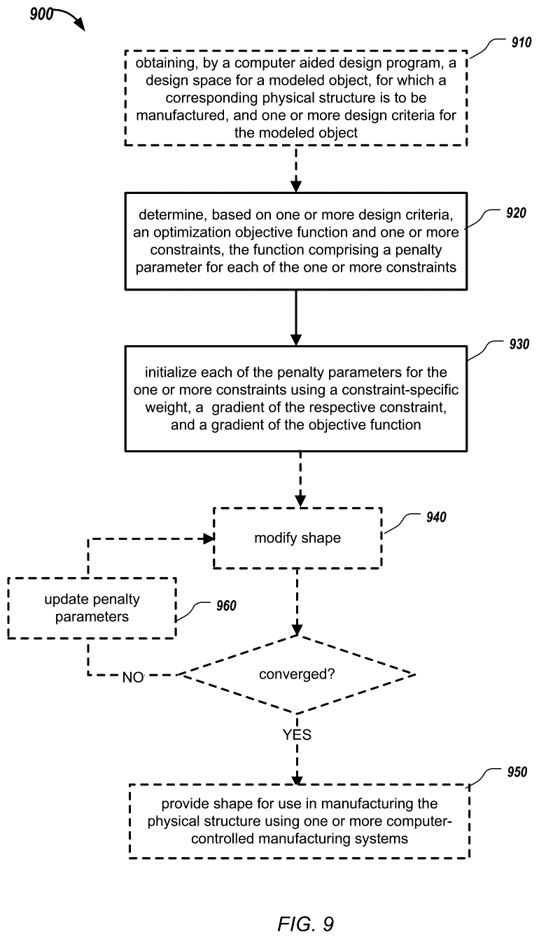

Then, the objective function and constraints are evaluated 604 in order to initialize 606 the penalty parameters. The Lagrange multipliers are also initialized 606. For example, the Lagrange multipliers can be initialized to zero. The initialization of the penalty parameters is described in further detail in relation to FIG. 9 below.

Then, an “inner loop” 608 starts where the shape derivatives are computed 610, the shape is updated 612 and the Lagrangian and constraints are re-evaluated 614. This inner loop repeats until convergence. If a density-based approach is used, density-based derivatives are computed instead of shape derivatives.

Then, it is checked whether the constraints have been satisfied. If they are not satisfied, the Lagrange multipliers and penalty parameters, are updated 620 to then form a new beam network 602, 603 and begin a new inner loop 608. This process repeats until process 600 converges with satisfied constraints. If the constraints are satisfied, the beam network is provided 618 for use in manufacturing using one or more computer-controlled manufacturing systems.

As the optimization progresses, the geometry becomes more beam-like and the extracted beam network becomes more reliable. In turn the penalty parameter for the beam constraint c_{beam} increases, and the geometry is gradually forced to align to the idealized beam network while still minimizing the overall compliance and maintaining the desired volume.

Convergence in the inner loop can be detected when the Lagrangian is reducing by less than a predetermined percentage between consecutive iterations. For example, convergence can be detected when the Lagrangian is reducing less than 2% between consecutive iterations. Convergence in the outer loop is determined by a converged inner loop and feasibility with respect to all constraints.

As described above, evaluating the constraints 604 can include evaluating the beam constraint. Evaluating the beam constraint can include evaluating 616 a (shape differentiable) beam constraint, e.g., a beam constraint that includes a normalization factor and a fall-off function (e.g., a Heaviside function).

The beam constraint can be defined as

$${𝒢}_{beam} ( Ω ) := \frac{1}{{N}_{D}} {\int }_{D} {H}_{beam ( Ω )} ( x ) {( {ϕ}_{Ω} ( x ) - {ϕ}_{beam ( Ω )} ( x ) )}^{2} dx$$

where D corresponds to the design domain containing all the geometry of interest, N_{D}=Volume(D)L² is a normalization factor and L is a characteristic size for the problem. For example, L can be chosen to be equal to one of the dimensions of the design domain. In some examples, L can be chosen to be equal to a maximum length of the initial 3D design space. This normalization makes the problem unit-less and size independent and a universal tolerance can be used for the constraint in the optimization algorithm. If a density-based approach is used, the beam constraint G_{beam} can be defined in a similar manner, where the above square difference in signed distance fields of the current shape and the beam network can be replaced by a squared difference in densities of the current geometry and the beam network.

H_{beam(Ω)}(x) is an influence function that limits the influence of the beam constraint. H_{beam(Ω)}(x) can be any suitable fall-off function. For instance, H_{beam(Ω)}(x) can be a smoothed Heaviside function. For example, the smoothed Heaviside function can limit the influence of the constraint up to a distance k away from ϕ_{beam(Ω)}=0 such as

$${H}_{beam ( Ω )} ( x ) = \{ \begin{matrix}0 & if k - {ϕ}_{beam ( Ω )} ( x ) < 0 \\ 1 & if k - {ϕ}_{beam ( Ω )} ( x ) > 2 \\ \frac{k - {ϕ}_{beam ( Ω )} ( z )}{2} & otherwise\end{matrix} .$$

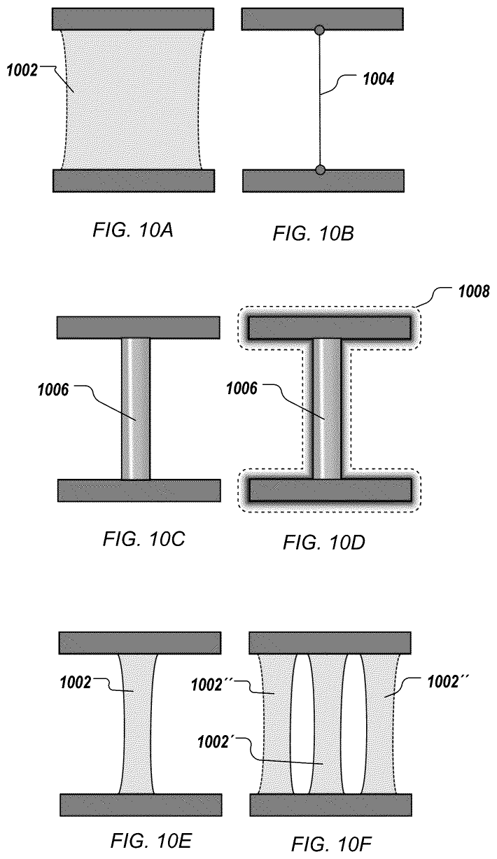

This can play an important role when the constraint is applied to a thin “sheet-like” structure like the initial “sheet-like” geometry 1002 shown in FIG. 10A. In this case, the skeleton will detect a single path through the sheet, resulting in a beam network with just one beam connection to replace the sheet. This is shown in FIGS. 10B and 10C, which show respectively the extracted graph including edge 1004 and the corresponding idealized beam geometry beam (Ω) including a single beam 1006. This beam can be far weaker than the sheet it replaces.

The extent 1008 of the corresponding Heaviside influence function H_{beam(Ω)} is shown in FIG. 10D with a dashed line. FIG. 10E shows modified geometry 1002 optimized without H_{beam(Ω)}. The whole geometry 1002 has moved to match the idealized beam shape 1006. However, when H_{beam(Ω)} is included, the beam constraint is limited by the extent 1008 of H_{beam(Ω)} and does not act on the remaining geometry of the sheet. As shown in FIG. 10F, only geometry 1002′ close to beam 1006 matches the idealized beam shape 1006 by forming new holes, and the rest of the geometry 1002″ is free, allowing additional beams to form. The end result is often that the sheet is replaced by a small network of beams instead of a single beam and is much better at resisting the loads. The distance k affects how densely beams can be formed within the sheet. For example, the distance k can be selected to be equal to a maximum desired beam thickness.

As shown above in relation to FIG. 6, the augmented Lagrangian algorithm involves the calculation of density-based gradients of the constraints in a density-based approach and the calculation of shape gradients of the constraints in a boundary-based approach. Determining a shape derivative of G_{beam} involves calculating a shape derivative of ϕ_{beam(Ω)}, which may not exist. Instead of using the above G_{beam}, a shape-differentiable approximation of G_{beam} can be used. This approximation can be evaluated 616 adaptively throughout the course of the augmented Lagrangian algorithm. In each inner iteration 608 the beam network can be frozen to be the beam network corresponding to the first inner iteration, Ωᵢₙᵢₜ. The approximate beam network constraint \tilde{G}_{beam} for this inner iteration can then be defined as

$${\tilde{𝒢}}_{beam} ( Ω ) := \frac{1}{{N}_{D}} {\int }_{D} {{H}_{beam ( Ω init )} ( x ) [ {ϕ}_{Ω} ( x ) - {ϕ}_{beam ( Ω init )} ( x ) ]}^{2} dx$$

Then, when this inner iteration is complete, \tilde{G}_{beam} can be updated by replacing Ωᵢₙᵢₜ with the shape reached at the end of this inner iteration. This approximate beam network constraint is shape-differentiable since it only depends on Ω through the signed distance function ϕ_{Ω}, which is shape-differentiable.

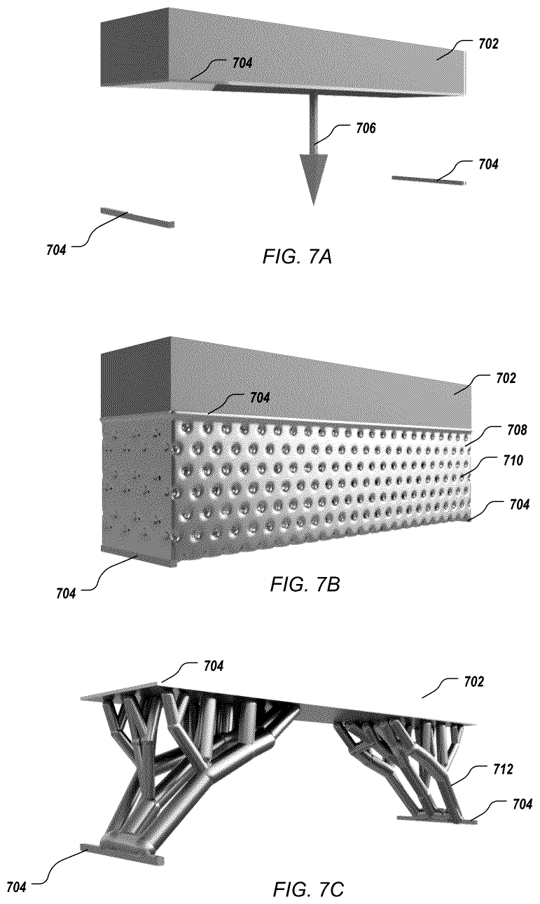

FIGS. 7A-7C show an example of a topology optimization of a footbridge structure with a distributed vertical load 706 over its surface 704 and is fixed (zero displacement) at bars 704 at the two ends below the bridge. Region 702 defines a keep-out region that the optimized shape cannot overlap with. Regions 704 are keep-in regions. FIG. 7B depicts the initial shape 708 seeded with holes 710. FIG. 7C depicts the final beam structure 712. The material has Young's modulus 193000 MPa, and a Poisson's ratio of 0.3. A volume constraint and the beam constraint were imposed.

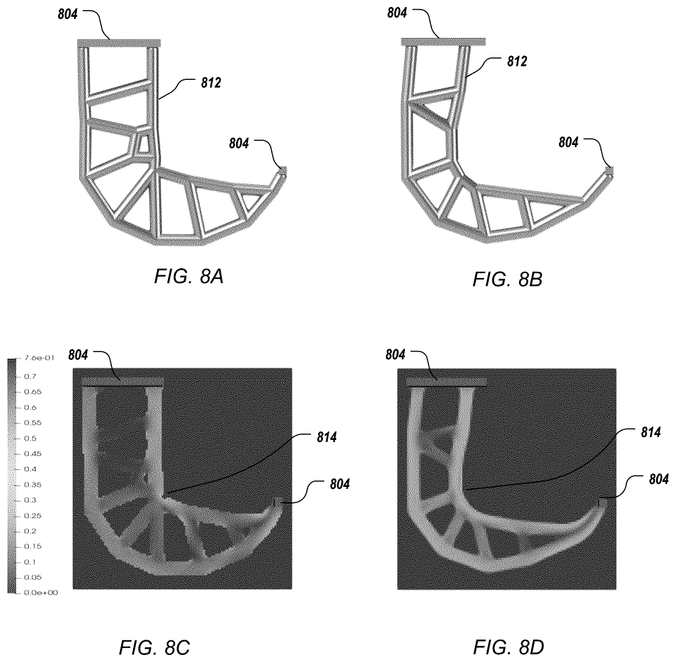

FIGS. 8A-8D show examples of topology optimization of an L-bracket according to different design objectives. FIG. 8A shows the resulting L-bracket for a compliance objective function. Regions 804 are keep-in regions. Beams 812 are cylindrical beams. FIG. 8B shows the resulting L-bracket for a p-norm stress objective

$$ℱ ( Ω ) := {( {\int }_{Ω} {σ}_{vm}^{P} d Ω )}^{\frac{1}{P}} ,$$

where p is the p-norm parameter used to approximate the max(⋅) operator and σᵥₘ is the von Mises stress. FIGS. 8C and 8D show the resulting stress fields for both L-brackets. As shown in FIG. 8C, without the p-norm stress objective, a stress concentration 814 appears at the inside corner of the L-bracket, just as in unconstrained compliance-based topology optimization. However, as shown in FIG. 8D, the p-norm stress objective combined with the beam constraint produces a result without stress concentrations, spreading the stress 814 across several beams.

FIG. 9 is a flowchart of a process 900 for topology optimization including an initialization 930 of penalty parameters. Method 900 can also include a step of obtaining 910 a design space for a modeled object for which a physical structure is to be manufactured, and one or more design criteria for the modeled object. Based on the one or more design criteria, an optimization objective function and one or more constraints can be determined 920. The function can be an augmented Lagrangian function comprising Lagrange multipliers and a penalty parameter for each of the one or more constraints, as shown above.

As shown above, a shape of the modeled object can be modified 940 and the augmented Lagrangian function can be minimized by performing a series of gradient descent loops to convergence while holding the Lagrange multipliers and penalty values constant for each loop and updating them before the start of the next loop. This approach requires initializing 930 values for the penalty parameters.

The penalty parameter associated with the constraint function G can be initialized 930 using

$${c}_{init} = \frac{w \vert d ℱ ( Ω ) \vert}{\vert d 𝒢 ( Ω ) \vert d 𝒢 ( Ω )} ,$$

where w is a constraint-specific weighting.

This penalty parameter initialization can also be used in process 600 to initialize 606 the penalty parameters. This penalty parameter initialization has the effect of normalizing the shape gradients of the constraints to the shape gradient of the objective such that all the constraints and the objective have an effect on the initial shape change equivalent to their weighting w. The Lagrange multipliers of the augmented Lagrange function can be initialized 606 to zero and from there, the optimization progresses and during parameter updates 960, the strengths of the constraint penalties cᵢ are increased as needed and the Lagrange multipliers are updated. This process repeats until process 900 converges with satisfied constraints. If the constraints are satisfied, the resulting shape is provided 950 for use in manufacturing using one or more computer-controlled manufacturing systems.

Although penalty parameters initialization 930 is shown as part of a topology optimization method 900, step 930 can be used to initialize penalty parameters for an augmented Lagrangian method in optimization problems other than topology optimization.

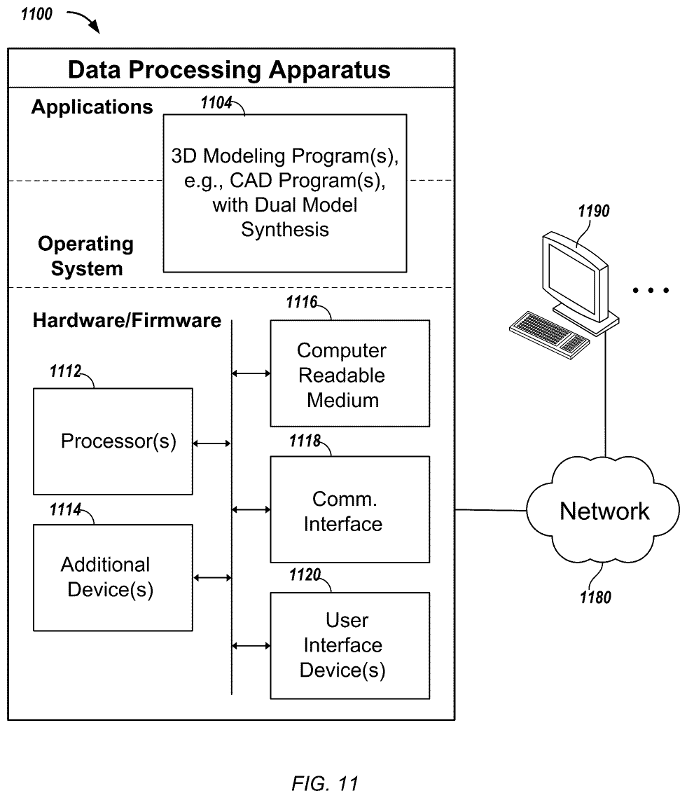

FIG. 11 is a schematic diagram of a data processing system including a data processing apparatus 1100, which can be programmed as a client or as a server. The data processing apparatus 1100 is connected with one or more computers 1190 through a network 1180. While only one computer is shown in FIG. 11 as the data processing apparatus 1100, multiple computers can be used. The data processing apparatus 1100 includes various software modules, which can be distributed between an applications layer and an operating system. These can include executable and/or interpretable software programs or libraries, including tools and services of one or more 3D modeling programs 1104 that implement dual model shape synthesis, as described above. Thus, the 3D modeling program(s) 1104 can be CAD program(s) 1104 (such as CAD program(s) 116) and can implement one or more boundary-based (e.g., level set) or density-based methods for topology optimization and physical simulation operations (finite element analysis (FEA) or other). Further, the program(s) 1104 can potentially implement manufacturing control operations (e.g., generating and/or applying toolpath specifications to effect manufacturing of designed objects). The number of software modules used can vary from one implementation to another. Moreover, the software modules can be distributed on one or more data processing apparatus connected by one or more computer networks or other suitable communication networks.

The data processing apparatus 1100 also includes hardware or firmware devices including one or more processors 1112, one or more additional devices 1114, a computer readable medium 1116, a communication interface 1118, and one or more user interface devices 1120. Each processor 1112 is capable of processing instructions for execution within the data processing apparatus 1100. In some implementations, the processor 1112 is a single or multi-threaded processor. Each processor 1112 is capable of processing instructions stored on the computer readable medium 1116 or on a storage device such as one of the additional devices 1114. The data processing apparatus 1100 uses the communication interface 1120 to communicate with one or more computers 1190, for example, over the network 1180. Examples of user interface devices 1120 include a display, a camera, a speaker, a microphone, a tactile feedback device, a keyboard, a mouse, and VR and/or AR equipment. The data processing apparatus 1100 can store instructions that implement operations associated with the program(s) described above, for example, on the computer readable medium 1116 or one or more additional devices 1114, for example, one or more of a hard disk device, an optical disk device, a tape device, and a solid state memory device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a non-transitory computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, e.g., after delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display) display device, an OLED (organic light emitting diode) display device, or another monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a browser user interface through which a user can interact with an implementation of the subject matter described is this specification, or any combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. In addition, actions recited in the claims can be performed in a different order and still achieve desirable results.

What is claimed is:

1. A method comprising:
obtaining, by a computer aided design program, a design space for a modeled object, for which a corresponding physical structure is to be manufactured, and one or more design criteria for the modeled object;
iteratively modifying, by the computer aided design program, a first three-dimensional shape of the modeled object in the design space in accordance with the one or more design criteria, wherein the iteratively modifying comprises
forming a second three-dimensional shape of the modeled object based on the first three-dimensional shape of the modeled object, wherein the second three-dimensional shape conforms to a predefined shape-type requirement, and
penalizing modifications of the first three-dimensional shape that deviate from the second three-dimensional shape; and
providing, by the computer aided design program, the first or second three dimensional shape of the modeled object for use in manufacturing the physical structure using one or more computer-controlled manufacturing systems.

2. The method of claim 1, wherein forming the second three-dimensional shape comprises:
extracting a graph from the first three-dimensional shape of the modeled object; and
generating the second three-dimensional shape from the graph, wherein the predefined shape-type requirement is that the second three-dimensional shape is a network of beams.

3. The method of claim 2, wherein generating the second three-dimensional shape from the graph comprises:
generating each of the beams of the network of beams from a respective edge of the graph, wherein each of the beams is assigned a circular cross-section of uniform radius along the beam.

4. The method of claim 2, wherein the generating comprises one or more of:
i) limiting a maximum and/or a minimum value of a beam cross-section of each of the beams of the network of beams;
ii) snapping an angle between connected beams to a snapping angle closest to the angle between the connected beams, wherein the snapping angle is equal to a specified angle value or a multiple of the specified angle value; or
iii) modifying a cross-section of one or more beams of the network of beams to decrease cross-section differences between substantially collinear beams.

5. The method of claim 4, wherein the generating comprises the snapping, which comprises solving an optimization problem on the graph using an objective function that measures differences between i) an angle between connected edges of the graph and ii) the closest snapping angle.

6. The method of claim 4, wherein the generating comprises the modifying, which comprises iteratively updating a radius of each beam taking into account the angle between a respective edge in the graph and edges connected to the respective edge, using a higher contribution from connected edges that are substantially collinear.

7. The method of claim 2, wherein the first three-dimensional shape is stored as a shape boundary representation, and wherein the penalizing comprises applying a beam network constraint that penalizes a difference between the network of beams and the shape boundary representation.

8. The method of claim 7, wherein the iteratively modifying comprises performing an iterative topology optimization process and increasing a weight of the beam network constraint at least at an end portion of the iterative topology optimization process.

9. The method of claim 7, wherein the beam network constraint comprises:
a normalization factor that depends on a volume of the design space and on a characteristic size; and
a fall-off function that limits an influence of the beam network constraint.

10. The method of claim 9, wherein the fall-off function is a smoothed Heaviside function that limits the influence of the beam network constraint up to a predetermined distance away from the network of beams.

11. The method of claim 9, wherein the beam network constraint is approximated using a shape-differentiable constraint.

12. The method of claim 11, wherein the iteratively modifying comprises iteratively:
performing a shape gradient descent until convergence using a function that combines a topology optimization objective function and one or more constraints, wherein the one or more constraints comprise the shape-differentiable constraint; and
updating respective penalty parameters of the one or more constraints.

13. The method of claim 12, comprising:
initializing each of the penalty parameters of the one or more constraints using a constraint-specific weight, a shape gradient of the respective constraint, and a shape gradient of the objective function.

14. The method of claim 2, wherein one or more beams are assigned a non-circular cross-section, the generating comprising:
determining locally optimal orientations for each of the one or more beams using
i) a shape of the first three-dimensional shape along a respective edge of the graph, or
ii) directions of forces acting on each of the one or more beams, the directions of forces determined from force fields for the first three-dimensional shape.

15. The method of claim 2, wherein generating the second three-dimensional shape from the graph comprises:
generating each of the beams of the network of beams from a respective edge of the graph, wherein each of the beams is a curved beam generated by fitting a curve to approximate a medial axis of a portion of the first 3D shape for each respective edge of the graph.

16. A method comprising:
obtaining, by a computer aided design program, a design space for a modeled object, for which a corresponding physical structure is to be manufactured, and one or more design criteria for the modeled object;
determining, based on the one or more design criteria, a topology optimization objective function and one or more constraints;
determining a function to be minimized, wherein the function combines the topology optimization objective function and the one or more constraints, the function comprising a penalty parameter for each of the one or more constraints;
initializing each of the penalty parameters for the one or more constraints using a constraint-specific weight, a shape gradient of the respective constraint, and a shape gradient of the objective function;
minimizing the function, wherein minimizing the function comprises adaptively updating the penalty parameters until convergence to obtain a shape of the modeled object that minimizes the function and satisfies the one or more design criteria; and
providing, by the computer aided design program, the shape of the modeled object for use in manufacturing the physical structure using one or more computer-controlled manufacturing systems.

17. A system comprising:
one or more processors; and
a computer-readable medium storing instructions that cause the one or more processors to perform operations comprising
obtaining, by a computer aided design program, a design space for a modeled object, for which a corresponding physical structure is to be manufactured, and one or more design criteria for the modeled object;
iteratively modifying, by the computer aided design program, a first three-dimensional shape of the modeled object in the design space in accordance with the one or more design criteria, wherein the iteratively modifying comprises
forming a second three-dimensional shape of the modeled object based on the first three-dimensional shape of the modeled object, wherein the second three-dimensional shape conforms to a predefined shape-type requirement, and
penalizing modifications of the first three-dimensional shape that deviate from the second three-dimensional shape; and
providing, by the computer aided design program, the first or second three dimensional shape of the modeled object for use in manufacturing the physical structure using one or more computer-controlled manufacturing systems.

18. The system of claim 17, wherein extracting a graph from the first three-dimensional shape of the modeled object; and
generating the second three-dimensional shape from the graph, wherein the predefined shape-type requirement is that the second three-dimensional shape is a network of beams.

19. The system of claim 18, wherein generating the second three-dimensional shape from the graph comprises:
generating each of the beams of the network of beams from a respective edge of the graph, wherein each of the beams is assigned a circular cross-section of uniform radius along the beam.

20. The system of claim 18, wherein the generating comprises one or more of:
i) limiting a maximum and/or a minimum value of a beam cross-section of each of the beams of the network of beams;
ii) snapping an angle between connected beams to a snapping angle closest to the angle between the connected beams, wherein the snapping angle is equal to a specified angle value or a multiple of the specified angle value; or
iii) modifying a cross-section of one or more beams of the network of beams to decrease cross-section differences between substantially collinear beams.
